(19) United States
(12) Patent Application Publication
(10) Pub. No.: US 2023/0297332 A1
(43) Pub. Date: Sep. 21, 2023

(54) INPUT TABLE NORMALIZATION SYSTEMS

(71) Applicant: Microsoft Technology Licensing, LLC, Redmond, WA (US)

(72) Inventors: Hadas Orgad, Haifa (IL); Hani Hana Neuvirth, Tel Aviv (IL); Moshe ISRAEL, Ramat-Gan (IL); Ofer Shezaf, Kibbutz Yiftah (IL); Ishai Wertheimer, Givat Shmuel (IL); Yaron David Fruchtmann, Hertzliya (IL)

(73) Assignee: Microsoft Technology Licensing, LLC, Redmond, WA (US)

(21) Appl. No.: 17/700,157

(22) Filed: Mar. 21, 2022

(51) Int. Cl. G06F 7/08; G06F 16/22

(52) U.S. Cl. CPC G06F 7/08; G06F 16/221

(57) ABSTRACT

Methods and systems to normalize an input table having a plurality of input table columns with a normalized table having a plurality of normalized table columns are disclosed. For each normalized column identifier associated with a normalized column of the normalized table, a compatibility score is computed for the normalized column identifier and each input column identifier associated with an input column of the input column table to provide set of compatibility scores associated with each normalized column identifier and input column identifier pair. A combinatorial optimization is applied to determine a match for each normalized column identifier with an input column identifier. Data associated with an input column of the input column identifier is mapped to the normalized column of the normalized column identifier matched with the input column identifier.

### BACKGROUND

Security information and event management (SIEM) relates to computer products and services that provide for detection, analytics, and response to issues of applications and devices such as network hardware. SIEM software products and services can combine security information management (SIM) and security event management (SEM). SIEM products and services can gather monitored data, and sort the data into categories for insights, visualization, analysis, response, and compliance. Products and services can include data inspection tools to ostensibly centralize the storage and interpretation of logs or events generated by other software running on a network. For instance, many systems and applications that run on a computer network generate events which are kept in event logs. The logs are lists of activities that occurred, with records of new events being appended as they occur. Protocols can be used to transport these events, as they occur, to logging software that is not on the same host on which the events are generated, and log management can be used to categorize the logs for analysis. Log management tools can be used to aggregate data from many sources.

### SUMMARY

This summary is provided to introduce a selection of concepts in a simplified form that are further described below in the Description. This summary is not intended to identify key features or essential features of the claimed subject matter, nor is it intended to be used to limit the scope of the claimed subject matter.

Methods and systems to normalize an input table having a plurality of input table columns with a normalized table having a plurality of normalized table columns are disclosed. For each normalized column identifier associated with a normalized column of the normalized table, a compatibility score is computed for the normalized column identifier and each input column identifier associated with an input column of the input column table to provide set of compatibility scores associated with each normalized column identifier and input column identifier pair. An example of an identifier can include a label associated with the column. A combinatorial optimization is applied to determine a match for each normalized column identifier with an input column identifier. Data associated with an input column of the input column identifier is mapped to the normalized column of the normalized column identifier matched with the input column identifier.

For example, a system can implement a method that is applied to a normalized table having a plurality of normalized table columns, and each of the normalized table columns is associated with a normalized table column identifier. The method is also applied to an input table having a plurality of input table columns, and each of the input table columns is associated with an input table column identifier. Input data from a data source is received into an input table column, and one or more data sources can provide data to the plurality of input table columns. For each column identifier of the normalized table, a compatibility score is computed for the column identifier of the normalized table and each column identifier of the input table. In one example, each unique pair of normalized table column identifier and input table column identifier is associated with a corresponding compatibility score. In one example, the compatibility score can be based on the cosine similarity of a word embedding of the normalized table column identifier and a word embedding of the input table column identifier in the corresponding normalized table column identifier and input table column identifier pair. For each normalized table column identifier of the normalized table, the associated compatibility scores are applied to determine an input column identifier of the input table as a match to the normalized table column identifier. In one example, the matching input column identifier of the input table is based on a combinatorial optimization for each normalized table column identifier applied to each input table column identifier. For instance, the Hungarian Method is implemented as a software product and applied to the compatibility scores associated with each unique pair of normalized table column identifier and input table column identifier formulated as an assignment problem. Each input table column identifier is associated with a corresponding matched normalized table column identifier. The data associated with an input column identifier of the input table is mapped to the column associated with the corresponding matched normalized table column identifier.

### BRIEF DESCRIPTION OF THE DRAWINGS

The accompanying drawings are included to provide a further understanding of embodiments and are incorporated in and constitute a part of this disclosure. The drawings illustrate embodiments and together with the description serve to explain principles of embodiments. Other embodiments and many of the intended advantages of embodiments will be readily appreciated, as they become better understood by reference to the following description. The elements of the drawings are not necessarily to scale relative to each other. Like reference numerals designate corresponding similar parts.

FIG. 1 is a block diagram illustrating an example of a computing device, which can be configured in a computer network to provide, for example, a cloud-computing environment.

FIG. 2 is a block diagram illustrating an example computer network such as a cloud-computing environment that can be implemented with the computing device of FIG. 1 to include a network monitoring system.

FIG. 3 is a block diagram illustrating an example method that can be implemented with the example network monitoring system of the computing network of FIG. 2.

FIG. 4 is a block diagram illustrating an example method that can be included as a feature of the method 300 of FIG. 3.

### DESCRIPTION

In the following Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following description, therefore, is not to be taken in a limiting sense. It is to be understood that features of the various example embodiments described herein may be combined, in part or whole, with each other, unless specifically noted otherwise.

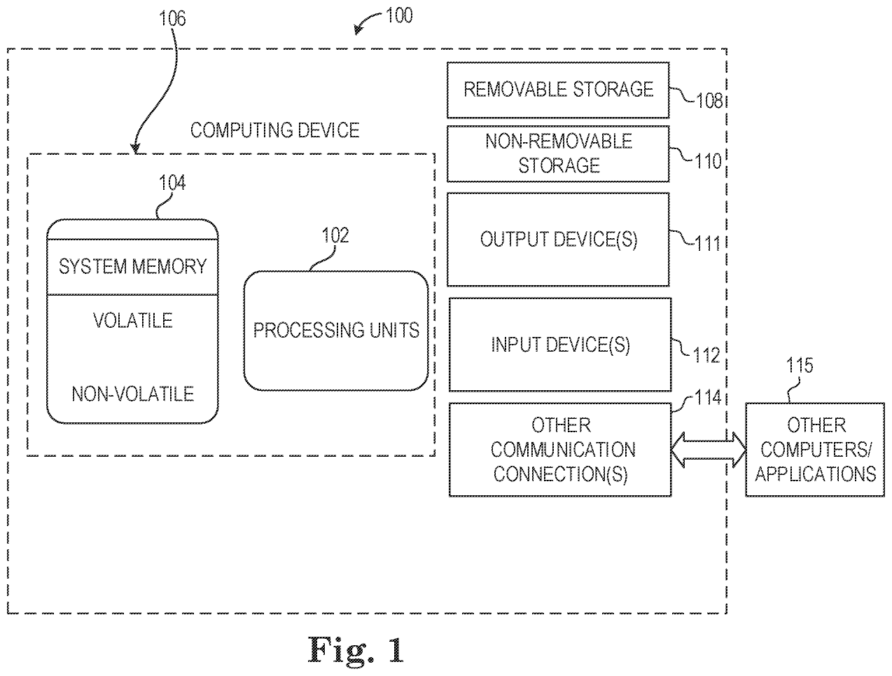

FIG. 1 illustrates an exemplary computer system that can be employed in an operating environment and used to host or run a computer application included on one or more computer readable storage mediums storing computer executable instructions for controlling the computer system, such as a computing device, to perform a process. The exemplary computer system includes a computing device, such as computing device 100. The computing device 100 can take one or more of several forms. Such forms include a tablet, a personal computer, a workstation, a server, a handheld device, a consumer electronic device (such as a video game console or a digital video recorder), or other, and can be a stand-alone device or configured as part of a computer network.

In a basic hardware configuration, computing device 100 typically includes a processor system having one or more processing units, i.e., processors 102, and memory 104. By way of example, the processing units may include two or more processing cores on a chip or two or more processor chips. In some examples, the computing device can also have one or more additional processing or specialized processors (not shown), such as a graphics processor for general-purpose computing on graphics processor units, to perform processing functions offloaded from the processor 102. The memory 104 may be arranged in a hierarchy and may include one or more levels of cache. Depending on the configuration and type of computing device, memory 104 may be volatile (such as random access memory (RAM)), non-volatile (such as read only memory (ROM), flash memory, etc.), or some combination of the two.

Computing device 100 can also have additional features or functionality. For example, computing device 100 may also include additional storage. Such storage may be removable or non-removable and can include magnetic or optical disks, solid-state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 100. Accordingly, a propagating signal by itself does not qualify as storage media. Any such computer storage media may be part of computing device 100.

Computing device 100 often includes one or more input and/or output connections, such as USB connections, display ports, proprietary connections, and others to connect to various devices to provide inputs and outputs to the computing device. Input devices 112 may include devices such as keyboard, pointing device (e.g., mouse, track pad), stylus, voice input device, touch input device (e.g., touchscreen), or other. Output devices 111 may include devices such as a display, speakers, printer, or the like.

Computing device 100 often includes one or more communication connections 114 that allow computing device 100 to communicate with other computers/applications 115. Example communication connections can include an Ethernet interface, a wireless interface, a bus interface, a storage area network interface, and a proprietary interface. The communication connections can be used to couple the computing device 100 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the interne, or other network.

In one example, one or more of computing device 100 can be configured as a client device for a user in the network. The client device can be configured to establish a remote connection with a server on a network in a computing environment. The client device can be configured to run applications or software such as operating systems, web browsers, cloud access agents, terminal emulators, or utilities.

In one example, one or more of computing devices 100 can be configured as servers in a datacenter to provide distributed computing services such as cloud computing services. A data center can provide pooled resources on which customers or tenants can dynamically provision and scale applications as needed without having to add servers or additional networking. The datacenter can be configured to communicate with local computing devices such used by cloud consumers including personal computers, mobile devices, embedded systems, or other computing devices. Within the data center, computing device 100 can be configured as servers, either as stand alone devices or individual blades in a rack of one or more other server devices. One or more host processors, such as processors 102, as well as other components including memory 104 and storage 110, on each server run a host operating system that can support multiple virtual machines. A tenant may initially use one virtual machine on a server to run an application. The datacenter may activate additional virtual machines on a server or other servers when demand increases, and the datacenter may deactivate virtual machines as demand drops.

Datacenter may be an on-premises, private system that provides services to a single enterprise user or may be a publicly (or semi-publicly) accessible distributed system that provides services to multiple, possibly unrelated customers and tenants, or may be a combination of both. Further, a datacenter may be a contained within a single geographic location or may be distributed to multiple locations across the globe and provide redundancy and disaster recovery capabilities. For example, the datacenter may designate one virtual machine on a server as the primary location for a tenant's application and may activate another virtual machine on the same or another server as the secondary or back-up in case the first virtual machine or server fails.

A cloud-computing environment is generally implemented in one or more recognized models to run in one or more network-connected datacenters. A private cloud deployment model includes an infrastructure operated solely for an organization whether it is managed internally or by a third-party and whether it is hosted on premises of the organization or some remote off-premises location. An example of a private cloud includes a self-run datacenter. A public cloud deployment model includes an infrastructure made available to the general public or a large section of the public such as an industry group and run by an organization offering cloud services. A community cloud is shared by several organizations and supports a particular community of organizations with common concerns such as jurisdiction, compliance, or security. Deployment models generally include similar cloud architectures, but may include specific features addressing specific considerations such as security in shared cloud models.

Cloud-computing providers generally offer services for the cloud-computing environment as a service model provided as one or more of an infrastructure as a service, platform as a service, and other services including software as a service. Cloud-computing providers can provide services via a subscription to tenants or consumers. For example, software as a service providers offer software applications as a subscription service that are generally accessible from web browsers or other thin-client interfaces, and consumers do not load the applications on the local computing devices. Infrastructure as a service providers offer consumers the capability to provision processing, storage, networks, and other fundamental computing resources where the consumer is able to deploy and run software, which can include operating systems and applications. The consumer generally does not manage the underlying cloud infrastructure, but generally retains control over the computing platform and applications that run on the platform. Platform as a service providers offer the capability for a consumer to deploy onto the cloud infrastructure consumer-created or acquired applications created using programming languages, libraries, services, and tools supported by the provider. In some examples, the consumer does not manage or control the underlying cloud infrastructure including network, servers, operating systems, or storage, but has control over the deployed applications and possibly configuration settings for the application-hosting environment. In other examples, the provider can offer a combination of infrastructure and platform services to allow a consumer to manage or control the deployed applications as well as the underlying cloud infrastructure. Platform as a service providers can include infrastructure, such as servers, storage, and networking, and also middleware, development tools, business intelligence services, database management services, and more, and can be configured to support the features of the application lifecycle including one or more of building, testing, deploying, managing, and updating.

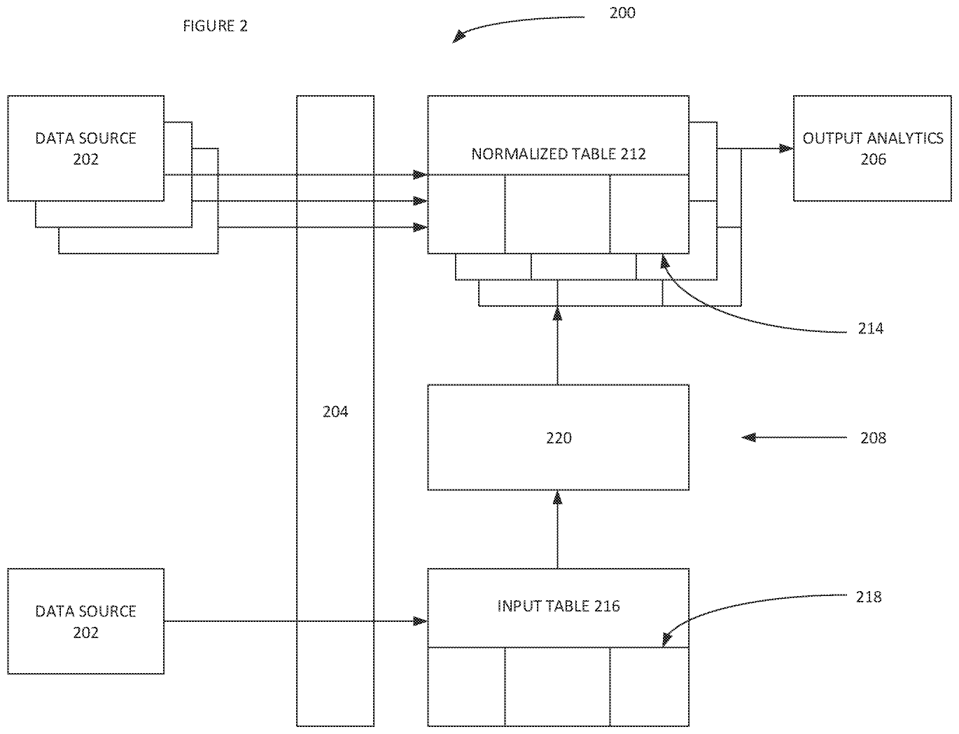

FIG. 2 illustrates an example computer network 200, such as a local network, a cloud computing network, or a combination of networks that may include a set of data sources 202, logging tools 204, and analytical tools 206, which may be implemented in a type of networked monitoring system 208. In one example, data sources 202 can be based on monitored resources on the network 200 that can include software applications running on devices and configured to provide data such as logs and metrics that may be in the form of messages. Logging tools 204 may include mechanisms for data, such as log, collection, aggregation, and storage and retention, and also include mechanisms that facilitate log analysis in real time and in bulk after storage, and for search and reporting. Analytical tools 206 can be applied to provide analysis, visualizations, and reporting of different aspects of the data and monitoring as well as alerts and an ability to respond to issues that may arise.

Data from the data sources 202 can be collected as part of logging tools 204. In one example, the logging tools 204 may sort the data from data sources into tables as part of a logging library. The monitoring system 208 may be configured to receive and collect data from many different sources, and often data sources can be provided in multiple formats such as via various data types or schemas. In one aspect, logging tools 204 includes mechanisms to normalize the data received so as to allow for analytics and analytics abilities on the data, particularly at scale, via analytical tools 206. In one example of normalization, the data may be collected in a normalized table 212, and the table 212 can include a set of columns 214 that are populated via a form a data or data from a data source. In an example of normalization, the normalized table 212 includes a relatively small number of normalized tables 212, and each normalized table 212 includes a limited number of columns 214.

The monitoring system 208 may be configured to, for example, receive input data from a new or different data source, a different data source provider, a different product, or in a different format of the data in addition to or instead of the data being collected in the normalized table 212. Such input data may be collected in an input table 216 that also includes a limited number of columns 218. Monitoring system 208 includes an input table mapping system 220 that is configured to map the columns 218 of the input table 216 to the columns 214 of the normalized table 212 or to discover and select an appropriate normalized table from a set of normalized tables 212 to which to map the columns 218 of the input table 216 to the columns 214 of the selected normalized table from the set of normalized tables 212.

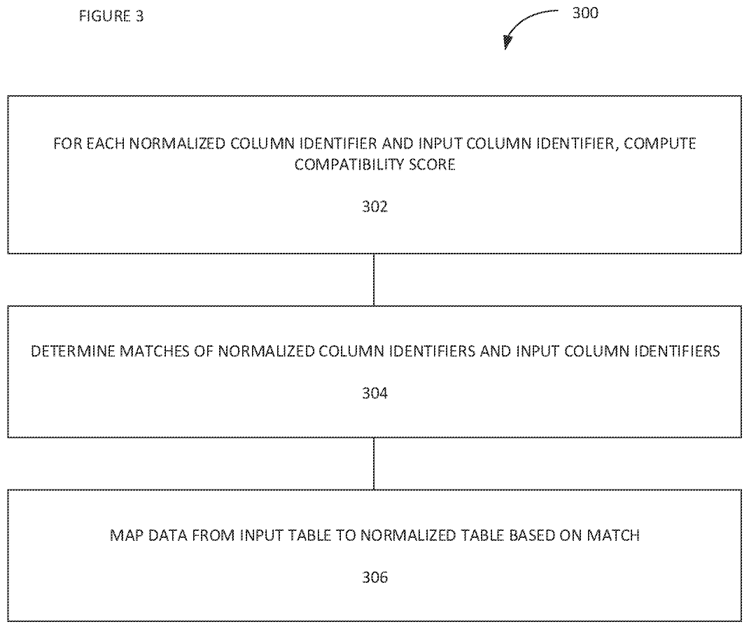

FIG. 3 illustrates an example method 300 performed with or assisted by the mapping system 220 of the monitoring system 208 in computer network 200. In one example, the method 300 is implemented as system having a processor and a memory device such as processor 102 and memory 104 on computing device 100. The memory device, such as memory 104 can be applied to store computer executable instructions for causing the processor 102 to perform the method 300, such as a program to map columns of an input table to a normalization table. The program to map an input table to a normalization table for mapping system 220 can reside in a memory device and be executed by a processor performs the method 300.

Method 300 is applied to a normalized table, such as normalized table 212 having a plurality of normalized table columns such as columns 214, and each of the normalized table columns is associated with a normalized table column identifier. Method 300 is also applied to an input table 216 having a plurality of input table columns 218, and each of the input table columns is associated with an input table column identifier. Input data from a data source is received into the input table columns. For each column identifier of the normalized table, a compatibility score is computed for the column identifier of the normalized table and each column identifier of the input table at 302. In one example, each unique pair of normalized table column identifier and input table column identifier is associated with a corresponding compatibility score. In one example, the compatibility score can be based on the cosine similarity of a word embedding of the normalized table column identifier and a word embedding of the input table column identifier in the corresponding normalized table column identifier and input table column identifier pair. For each normalized table column identifier of the normalized table, the associated compatibility scores are applied to determine an input column identifier of the input table as a match to the normalized table column identifier at 304. In one example, the matching input column identifier of the input table is based on a combinatorial optimization for each normalized table column identifier applied to each input table column identifier. In one example, the Hungarian Method is implemented as a software product and applied to the compatibility scores associated with each unique pair of normalized table column identifier and input table column identifier formulated as an assignment problem. Each input table column identifier is associated with a corresponding matched normalized table column identifier. In one example, method 300 can be applied to a set of normalized tables 212 to determine an appropriate match of a normalized table from the set of normalized table. The data associated with an input column identifier of the input table of the associated normalized table is mapped to the column associated with the corresponding matched normalized table column identifier at 306.

In one example presented here for illustration, the monitoring system 208 includes a log analysis application—which can be a software product, appliance, and managed service—can collect and organize log and performance data from monitored resources. Data from multiple sources can be consolidated into a single workspace of the log analysis application. The sources can include, for example, platform logs from cloud provider services, log and performance data from virtual machine agents, and usage and performance data from applications. In some examples, log analysis application can then analyze the data by using a query language that may analyze millions of records.

Log analysis application may be used in addition to, or as part of suite also including monitoring metrics application. Monitoring metrics applications typically store numeric data in a time-series data base, which can be more lightweight than data in the log analysis application. In some examples, monitoring metrics applications can support near real time scenarios and store numeric data in a particular structure. Log analysis application applications, however, typically store a variety of data types that can include their own structures. Further, log analysis applications can typically support complex analysis on the data using queries.

Data can be stored in an analytics workspace. In many examples, a single workspace may be enough for a data-monitoring environment. In other examples, multiple workspaces may be used, such as a workspace for production data and a separate workspace for testing data. Data can be retrieved from the workspace via a log query, which can be a read-only request to process data and return results. In one example, a log query may be written in a query language and applied to the workspace. For example, a log query can be written in a log analysis application and used to interactively analyze results, alert rules to be proactively notified of issues, or include results to be used in application workbooks or dashboards of the log analysis application.

An analytics workspace may include a table, such as one or more tables that are each organized into one or more columns, and each column includes zero or more rows of data. For instance, a column may begin with zero rows of data and can add rows as the column is populated with data. Each table can be defined by the unique set of columns. In one example, the rows of data in a column are provided by a data source. The column is associated with the data in the rows, the data source, and an identifier of the column.

The normalized table Nr includes a set of n columns, in which n is an integer greater than zero. The input table Ip also includes a set of n columns, in which n is an integer greater than zero.

A column of the normalized table Nr may be represented as cNrᵢ in which i in an integer from 1 to n. For example, the normalized table Nr may include a column having a column identifier, such as a column name, cNrᵢ that may be populated with data associated with the identifier and corresponding data source.

A column of the input table Ip may be represented as cIpⱼ in which j in an integer from 1 to n. For example, the input table Ir may include a column having a column identifier, such as a column name, cIpⱼ that may be populated with data associated with the identifier and corresponding data source.

For each column identifier of the normalized table, a compatibility score is computed for the column identifier of the normalized table and each column identifier of the input table at 302.

```
For example, for each i from 1 to n, do
  for each j from 1 to n,
    compute a compatibility_score(cNrᵢ, cIpⱼ).
```

In one example, the compatibility score can be based on the cosine similarity of a word embedding of the normalized table column identifier and a word embedding of the input table column identifier. The word embeddings can be pre-trained word embeddings. A combability score can be associated with each normalized table column identifier and input table column identifier (cNrᵢ, cIpⱼ) pair.

Word embeddings are used in natural language processing for the representation of words for text analysis, typically in the form of a real-valued vector that encodes the meaning of the word such that the words that are closer in the vector space are expected to be similar in meaning. Word embeddings can be obtained using a set of language modeling and feature learning techniques in which words or phrases from the vocabulary are mapped to vectors of real numbers and involves the mathematical embedding from space with many dimensions per word to a continuous vector space with a much lower dimension. Mechanisms to generate a mapping include neural networks, dimensionality reduction on the word co-occurrence matrix, probabilistic models, explainable knowledge base method, and explicit representation in terms of the context in which words appear. Pre-trained word embeddings are vector representation of words trained on a large dataset. Pre-trained word embeddings permit the application of the weights and vocabulary from the end result of a training process.

In data analysis, cosine similarity is a measure of similarity between two non-zero vectors of an inner product space. Cosine similarity of the vectors is the cosine of the angle between them, which is also the same as the inner product of the vectors normalized such that both vectors have length of 1. In this example, cosine similarity depends on the angle between the two non-zero vectors, but not on magnitudes of the vectors. The cosine similarity can be bounded in the interval [−1, 1]for any angle. For example, two vectors with the same orientation have a cosine similarity of 1, two vectors oriented at right angle relative to each other have a similarity of 0, and two vectors diametrically opposed have a similarity of −1. In some examples, the compatibility score can be adjusted from the cosine similarity score to be bounded in the interval [0, 1].

In examples of cosine similarity applied to word embeddings, a first combability score associated with normalized table column identifier identical to an input table column identifier may be 1 for the (cNrᵢ, cIpⱼ) pair. Further, a second combability score associated with normalized table column identifier similar to an input table column identifier may be greater than 0 but less than 1 for the (cNrᵢ, cIpⱼ) pair. Still further, a third combability score associated with normalized table column identifier dissimilar to an input table column identifier may be greater than 0 but less than the second compatibility score for the similar pair for the (cNrᵢ, cIpⱼ) pair.

For each normalized table column identifier of the normalized table, the associated compatibility scores are applied to determine an input column identifier of the input table as a match to the normalized table column identifier at 304. For instance, the higher compatibility score from the set of compatibility scores associated with each normalized table column identifier and input table column identifier (cNrᵢ, cIpⱼ) pair for a given normalized table column identifier or given input table column identifier is indicative of a matching pair. But based on the combinatorial aspect of the applying the set of normalized table column identifiers of the normalized table to the set of input table column identifiers of the input table, selecting the highest compatibility score from each normalized table column identifier and input table column identifier (cNrᵢ, cIpⱼ) pair for a given normalized table column identifier or given input table column identifier may, in some circumstances, yield an incorrect pair. In one example, method 300 may return z pairs associated with the z highest compatibility score from each normalized table column identifier and input table column identifier (cNrᵢ, cIpⱼ) pair for a given normalized table column identifier or given input table column identifier at 304, such as the z pairs sorted by compatibility score. Matches are selected from the returned pairs for each normalized table column identifier or input table column identifier. In this example, once a matching normalized table column identifier and input table column identifier (cNrᵢ, cIpⱼ) pair is selected for one of the given normalized table column identifier or given input table column identifier, the score associated with the other of the input table column identifier and normalized table column identifier in the remaining (cNrᵢ, cIpⱼ) pairs is set to zero such that the input table column identifier is not available for a match with another normalized table column identifier in the normalized table (or the normalized table column identifier is not available for a match with another input table column identifier in the input table) at 304. In the example, z is an integer of one or more and can be set to be equal to n, the number of columns such as in the normalized table.

In another example of applying the associated compatibility scores to determine an input column identifier of the input table as a match to the normalized table column identifier at 304, the matching input column identifier of the input table is based on a combinatorial optimization for each normalized table column identifier applied to each input table column identifier. Combinatorial optimization is form of programming, such as mathematical programming, to select the preferred element according to some criterion, and, at 304, includes finding or calculating the preferred matches between the set of normalized table column identifiers and the input table column identifiers via a complex process of 304. In one example, the Hungarian Method, a form of combinatorial optimization, is implemented as a software product and applied to the compatibility scores associated with each unique pair of normalized table column identifier and input table column identifier formulated as an assignment problem. The Hungarian method is particularly suited to solve an assignment problem in polynomial time. The set of normalized table column identifiers, the set of input table column identifiers along, and the compatibility scores for each normalized table column identifier and input table column identifier (cNrᵢ, cIpⱼ) pair are formulated as an assignment problem via a software product to which the Hungarian method is applied in a software product at 304. Each input table column identifier is associated with a corresponding matched normalized table column identifier at 304.

In a further example of applying the associated compatibility scores to determine an input column identifier of the input table as a match to the normalized table column identifier at 304, the matching input column identifier of the input table is based on a combinatorial optimization for each normalized table column identifier applied to each input table column identifier, such as with the Hungarian method, and z pairs associated with the z highest compatibility score from each normalized table column identifier and input table column identifier (cNrᵢ, cIpⱼ) pair for a given normalized table column identifier or given input table column identifier are returned at 304.

In one example, method 300 can be applied to a set of normalized tables 212 to determine an appropriate match of a normalized table from the set of normalized table; for instance via a total compatibility score as added from the compatibility scores of the columns of each normalized table of once each input table column identifier is associated with a corresponding matched normalized table column identifier.

The data associated with an input column identifier of the input table is mapped to the column associated with the corresponding matched normalized table column identifier at 306. For instance, data associated with an input column identifier of the input table is transferred to the column associated with the corresponding matched normalized table column identifier, and subsequent data associated with an input column identifier of the input table is populated in the first instance to the column associated with the corresponding matched normalized table column identifier.

In some examples, column identifiers can be in the form of a word, such as word that can be subjected to a word embedding to return a vector representation of the word. In this example, the compatibility score can be based on the cosine similarity of a word embedding of the normalized table column identifier and a word embedding of the input table column identifier. The method 300 can proceeds to computing a compatibility score for the column identifier of the normalized table and the column identifier of the input table from the cosine similarity of the word embeddings. In some examples, however, the column identifier may be in the form of an alias, a phrase, or a phrase including an alias. In these examples, additional processing is performed prior to computing the compatibility score.

For example, an alias of a word can include an abbreviation of a word or a short form of the word that is used to represent or stand in for the word. For example, an abbreviation or short form for Destination may include Dst, an abbreviation or short form for One may include 1, and abbreviation or short form for Number may include Num and No. Thus, an alias for Destination may be Dst, an alias for One may be 1, and aliases for Number may be Num and No. The alias may not include a corresponding word embedding, so additional processing may be applied to determine a word embedding for the alias.

In one example, aliases of words are replaced with words in the sub-identifier to aid in determining the word embedding. A word and its associated aliases can be stored together in a data structure. An alias can be applied to the data structure and its associated word can be returned via an indexing operation. For example, an identifier or sub-identifier Dst is replaced with Destination such as via the indexing operation. Known aliases of words can be periodically collected and associated with words, such as in a data structure stored in memory, and a word can be associated with an alias such as via array such as a look up table. Thus, the known aliases can be periodically collected and stored in a memory to be accessible to method 300.

In one example, mapping system 220 of the monitoring system may include a memory or have access to a set of aliases that may be associated with a given word. The set of aliases associated with the word may include one alias or many aliases. For example, the mapping system may include a plurality of sets of aliases in which each set of aliases is associated with a unique word. The word associated with the aliases can be subjected to a word embedding. The plurality of sets of aliases associated with words can be stored in an alias storage or alias repository that is including as part of network monitoring system 208. A program can be applied to the alias storage to receive an alias and return the associated word. For instance, processor 102 can be applied to receive an alias, apply the alias to the alias storage such as in memory 104, and return the associated word. Once identified, word is then used to replace the alias in the column identifier and to return a word embedding for computing the compatibility score. Aliases from both the normalized table column identifier and input column identifier can be applied to the alias storage via the processor 102. Data within the alias storage can be updated and maintained, such as an alias can be added to or removed from the set of aliases that is associated with a word as conventions change or additional aliases associated with the word are identified.

Often, column identifiers are in the form of phrases that are made up of sub-identifiers. For example, a column identifier can be the phrase “Destination Translated Port,” in which sub-identifiers are Destination, Translated, and Port. In the example, each sub-identifier is a word. In some examples, a sub-identifier may be an alias that is used to represent or stand in for the word. For example, an abbreviation or short form for Destination may include Dst, an abbreviation or short form for One may include 1, and abbreviation or short form for Number may include Num and No. Thus, an alias for Destination may be Dst, an alias for One may be 1, and aliases for Number may be Num and No.

Further, a column identifier can adhere to a naming convention of multiple sub-identifiers forming a phrase without spaces. Example naming conventions for multiple sub-identifiers can include flatcase, camelCase, PascalCase, snake_case, and kebab-case for words and aliases in phrases. Examples of column identifiers that adhere to a naming convention can include DestinationTranslatedPort, and Source_Translated_Address. Accordingly, a column identifier can include a phrase that is made of sub-identifiers including words and aliases that can adhere to a multiple-word naming convention, such as DstNatPortNumber.

Each normalized table column identifier cNrᵢ can include 1 to p sub-identifiers. Thus, each normalized table column identifier cNrᵢ can include a set of sub-identifiers subₐcNrᵢ in which a is an integer from 1 to p.

Each input table column identifier cIpⱼ can include 1 to q sub-identifiers. Thus, each input table column identifier cIpⱼ can include a set of sub-identifiers sub_{b}cIpⱼ in which b is an integer from 1 to q.

In the example nomenclature, a normalized table Nr can include normalized table column identifier cNrᵢ that is DstNatPortNumber, and this normalized table column identifier cNrᵢ includes p=4 sub-identifiers, namely, subᵢcNrᵢ is Dst, sub₂cNrᵢ, is Nat, sub₃cNrᵢ, is Port, and sub₄cNrᵢ is Number.

Also, an input table Ip can include an input table column identifier cIpⱼ that is DestinationTranslatedPort, and this input table column identifier cIpⱼ includes q=3 sub-identifiers, namely, sub₁cIpⱼ is Destination, sub₂cIpⱼ is Translated, sub₃cIpⱼ is Port.

To determine a compatibility score for a normalized column identifier and an input column identifier at 302 in which both the normalized table column identifier and the input table column identifier include sub-identifiers, similarity scores are used to make up a compatibility score at 302.

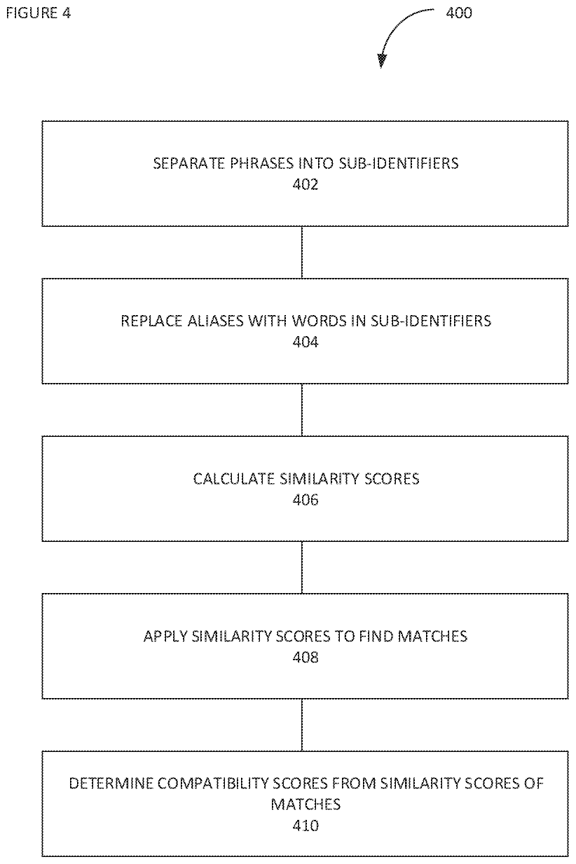

FIG. 4 illustrates an example method 400 performed with or assisted by the mapping system 220 of the monitoring system 208 in computer network 200, for example, to determine compatibility scores for a normalized column identifier and an input column identifier at 302 in which both the normalized table column identifier and the input table column identifier include sub-identifiers. In this example, both the normalized table column identifier and the input table column identifier are composed of phrases in which the phrases may include an alias. In one example, the method 400 is implemented as system having a processor and a memory device such as processor 102 and memory 104 on computing device 100. The memory device, such as memory 104 can be applied to store computer executable instructions for causing the processor 102 to perform the method 400, such as a program to implement a method to determine compatibility scores, such as at 302 in a program to map columns of an input table to a normalization table, such as a program that implements method 300. The program to determine compatibility scores such as a program for a program to map columns of an input table to a normalization table for mapping system 220 can reside in a memory device and be executed by a processor performs the method 400 and can reside in a memory device and be executed by a processor performs the method 300.

The method 400 is configured to separate the column identifiers provided or received in the method 300 to sub-identifiers at 402. In one example the column identifiers are separated in sub-identifiers such as by identifying the multiple-word naming convention and separating the sub-identifiers from the identifiers or some other suitable mechanism. For example, a program may be configured to identify spaces in phrases or flatcase, camelCase, PascalCase, snake_case, and kebab-case for words and aliases in phrases at 402. Sub-identifiers are separated and can be separately processed in method 400.

In some examples, a sub-identifier is in the form of an alias of a word. Sub-identifiers that are in the form of an alias are replaced with sub-identifiers in the form of words associated with the alias at 404. For example, method 400 may have access to alias storage such that an alias can be applied to the alias storage and an associated word subject to a word embedding is returned.

Aliases such as Dst can be replaced with associated words such as Destination prior to computation of the similarity score. The associated word is then applied as the sub-identifier for the determination of the similarity score and the compatibility score.

For each sub-identifier of the normalized table column identifier, a similarity score is computed for the sub-identifier of the normalized table column identifier and each sub-identifier of the input table column identifier at 406.

```
For example, for a given i and j, do
  for each a from 1 to p, do
    for each b from 1 to q,
      compute a similarlity_score(subₐcNrᵢ, sub_{b}cIpⱼ)
```

In one example, the similarity score can be based on the cosine similarity of a word embedding of the sub-identifier of the normalized table column identifier and a word embedding of the sub-identifier of the input table column identifier. The word embeddings can be pre-trained word embeddings. A similarity score can be associated with each sub-identifier of the normalized table column identifier and sub-identifier input table column identifier (subₐcNrᵢ, sub_{b}cIpⱼ) pair. In one example, computing the similarity score for a sub-identifier of the normalized table column identifier and a sub-identifier input table column identifier (subₐcNrᵢ, sub_{b}cIpⱼ) pair includes determining a cosine similarity for word embedding of (subₐcNrᵢ)and word embedding of (sub_{b}cIpⱼ). The word embeddings and cosine similarity can be determined in a manner similar to that in method 300 at 302.

In one example, a normalized table column identifier cNrᵢ can be DstNatPortNumber. The normalized table column identifier is a phrase that can be separated into sub-identifiers at 402. The sub-identifiers are (sub₁cNr₁) Dst, (sub₂cNrᵢ) Nat, (sub₃cNrᵢ) Port, and (sub₄cNrᵢ) Number. The sub-identifiers can be analyzed to determine aliases, such as Dst and Nat, which are replaced in the processing with associated words at 404.

The input table Ip includes an input table column identifier cIpⱼ that is DestinationTranslatedPort. The sub-identifiers include (sub₁cIpⱼ) Destination, (sub₂cIpⱼ) Translated, and (sub₃cIpⱼ) Port.

In this example, a similarity score is computed at 406 for each pair of:
(Dst, Destination), (Dst, Translated), (Dst, Port);
(Nat, Destination), (Nat, Translated), (Nat, Port);
(Port, Destination), (Port, Translated), (Port, Port);
(Number, Destination), (Number, Translated), (Number, Port).

The similarity score can be based on the cosine similarity of a word embedding of the sub-identifier of the normalized table column identifier and a word embedding of the sub-identifier of the input table column identifier.

In one example, the similarity score associated with a sub-identifier of the normalized table column identifier and sub-identifier input table column identifier (subₐcNrᵢ, sub_{b}cIpⱼ) pair can be a similarity score of 1 for the pair (Dst, Destination); a similarity score of 0.30 for the pair (Dst, Translated) and a similarity score of 0.35 for the pair (Dst, Port).

For each sub-identifier of the normalized table column identifier, the associated similarity scores are applied to determine a sub-identifier of the input column identifier as a match to the normalized table column identifier at 408. In one example, the matching sub-identifier of the input column identifier is based on a combinatorial optimization for each sub-identifier of the normalized table column identifier applied to each sub-identifier of the input table column identifier. In one example, the Hungarian Method is implemented as a software product and applied to the similarity scores associated with each unique pair of sub-identifier of the normalized table column identifier and sub-identifier of the input table column identifier formulated as an assignment problem. Each sub-identifier for the input table column identifier is associated with a corresponding matched sub-identifier of the normalized table column identifier.

The set of similarity scores of the matched sub-identifiers associated with a sub-identifier of the normalized table column identifier and sub-identifier input table column identifier (subₐcNrᵢ, sub_{b}cIpⱼ) pair are added together for each normalized table column identifier and input table column identifier (cNrᵢ, cIpⱼ) pair at 410 to provide a compatibility score for the normalized table column identifier and input table column identifier (cNrᵢ,cIpⱼ) pair. In one example, the sum of the similarity scores can be normalized by the number of sub-identifiers in the input table column identifier. For instance, the input table column identifier cIPⱼ that is DestinationTranslatedPort, and this input table column identifier cIpⱼ includes q=3 sub-identifiers, namely, sub₁cIpⱼ is Destination, sub₂cIpⱼ is Translated, sub₃cIpⱼ is Port, so the sum of the similarity scores associated with a match for each sub-identifiers Destination, Translated, and Port is normalized by its associated q, which is 3, in order to obtain the associated compatibility score. Accordingly, the similarity scores associated with a sub-identifier of the normalized table column identifier and sub-identifier input table column identifier (subₐcNrᵢ, sub_{b}cIpⱼ) pair that make up each normalized table column identifier and input table column identifier (cNrᵢ, cIpⱼ) pair are added to together and then normalized by the number of q sub-identifiers of the input table column identifier cIpⱼ to obtain an associated compatibility score for the normalized table column identifier and input table column identifier (cNrᵢ, cIpⱼ) pair. The combability score determined from the similarity scores at 410 can be applied in method 300, such as at 302.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. A method to normalize an input table having a plurality of input table columns with a normalized table having a plurality of normalized table columns, the method comprising:
for each normalized column identifier associated with a normalized column of the normalized table, computing a compatibility score for the normalized column identifier and each input column identifier associated with an input column of the input column table to provide a set of compatibility scores associated with each normalized column identifier and input column identifier pair;
applying a combinatorial optimization to determine a match for each normalized column identifier with an input column identifier; and
mapping data associated with an input column of the input column identifier to the normalized column of the normalized column identifier matched with the input column identifier.

2. The method of claim 1 comprising calculating preferred matches between the normalized table column identifiers and the input table column identifiers via an assignment problem.

3. The method of claim 1 wherein applying the combinatorial optimization includes applying the Hungarian method.

4. The method of claim 1 comprising returning a plurality of highest compatibility score from each normalized table column identifier and input table column identifier pair for a given normalized table column identifier or given input table column identifier.

5. The method of claim 1 wherein a normalized column identifier includes an alias and comprising replacing the alias with a word subject to a word embedding.

6. The method of claim 5 wherein replacing the alias with a word includes accessing an alias repository.

7. The method of claim 1 wherein the normalized column identifiers and input column identifier include phrases and comprising separating the phrases into sub-identifiers.

8. The method of claim 7 and comprising calculating similarity scores for pairs of sub-identifiers and adding similarity scores to obtain the compatibility score.

9. The method of claim 8 and comprising replacing words with sub-identifiers having an alias.

10. The method of claim 8 wherein obtaining the compatibility scores includes normalizing the added similarity score via a number of sub-identifiers.

11. A computer readable storage device to store computer executable instructions to control a processor to:
receive an input table having a plurality of input table columns and a normalized table having a plurality of normalized table columns;
for each normalized column identifier associated with a normalized column of the normalized table, compute a compatibility score for the normalized column identifier and each input column identifier associated with an input column of the input column table to set of compatibility scores associated with each normalized column identifier and input column identifier pair;
apply a combinatorial optimization to determine a match for each normalized column identifier with an input column identifier; and
map data associated with an input column of the input column identifier to the normalized column of the normalized column identifier matched with the input column identifier.

12. The computer readable storage device of claim 11 comprising for each normalized column identifier and input column identifier including a phrase, separate the phrase into a plurality of sub-identifiers, and for each sub-identifier including an alias, replace the alias with a word subject to a word embedding from an alias repository.

13. The computer readable storage device of claim 11 wherein the compatibility score is based on a cosine similarity of a word embedding of the normalized column identifier and a word embedding of the input column identifier.

14. The computer readable storage device of claim 11 wherein for each normalized column identifier, apply the set of associated compatibility scores to determine an input column identifier as a match to the normalized table column identifier.

15. The computer readable storage device of claim 11 including populating the data into the normalized column.

16. The computer readable storage device of claim 11 including calculate preferred matches between the normalized table column identifiers and the input table column identifiers via an assignment problem, and wherein apply the combinatorial optimization includes apply the Hungarian method.

17. A system, comprising:
a memory device to store a set of instructions; and
a processor to execute the set of instructions to:
receive an input table having a plurality of input table columns and a normalized table having a plurality of normalized table columns;
for each normalized column identifier associated with a normalized column of the normalized table, compute a compatibility score for the normalized column identifier and each input column identifier associated with an input column of the input column table to set of compatibility scores associated with each normalized column identifier and input column identifier pair;
apply a combinatorial optimization to determine a match for each normalized column identifier with an input column identifier; and
map data associated with an input column of the input column identifier to the normalized column of the normalized column identifier matched with the input column identifier.

18. The system of claim 17 included in a monitoring system.

19. The system of claim 18 included in a cloud-based environment.

20. The system of claim 17 configured to receive the data from a networked data source.
